(19) United States
(12) Patent Application Publication
(10) Pub. No.: US 2026/0104926 A1
(43) Pub. Date: Apr. 16, 2026

(54) MEMORY DEVICE AND MEMORY OPERATION METHOD

(71) Applicant: MACRONIX INTERNATIONAL CO., LTD., HSINCHU (TW)

(72) Inventor: Yu-Yu LIN, New Taipei City (TW)

(21) Appl. No.: 18/915,654

(22) Filed: Oct. 15, 2024

(51) Int. Cl. G06F 9/50; G06F 17/16

(52) U.S. Cl. CPC G06F 9/5016; G06F 9/5044; G06F 17/16

(57) ABSTRACT

A memory operation method, comprising: obtaining, by a processing circuit, a plurality of operation data of a vector-matrix multiplication, wherein the processing circuit is coupled to a memory array, and the memory array comprises a plurality of memory blocks; calculating a block number in the plurality of memory blocks required to store the plurality of operation data; allocating M memory blocks in the plurality of memory blocks according to the block number; and providing the plurality of operation data to the M memory blocks, so that the memory array outputs an output current according to the plurality of operation data and a plurality of weight values set in the M memory blocks.

### BACKGROUND

### TECHNICAL FIELD

The present disclosure relates to a memory operation method, particularly a memory device capable of performing vector-matrix multiplication.

### DESCRIPTION OF RELATED ART

As the computing speed of computers increases, the requirements for memory speed and stability are getting higher and higher. With many different market demands, how to improve the application of memory so that it can not only read and write data, but also be used as part of computing processing has become a major topic at present.

### SUMMARY

One aspect of the present disclosure is a memory device, comprising a memory array, a sensing circuit and a processing circuit. The memory array is coupled to a plurality of word lines and a plurality of bit lines, and comprises a plurality of memory blocks. Each of the plurality of memory blocks comprises a plurality of memory strings. The sensing circuit is coupled to the memory array, and is configured to receive an output current output by the memory array. The processing circuit is coupled to the memory array, and is configured to calculate a block number in the plurality of memory blocks required to store a plurality of operation data of a vector-matrix multiplication. The processing circuit is further configured for: allocating M memory blocks in the plurality of memory blocks according to the block number; and providing the plurality of operation data to the M memory blocks, so that the memory array outputs the output current according to the plurality of operation data and a plurality of weight values set in the M memory blocks. Accordingly, by selectively allocating the operation data to different regions of the memory array, vector-matrix multiplication can be realized more flexibly.

In one embodiment, the memory array comprises a plurality of available regions, and the processing circuit is configured to select at least one of the plurality of available regions as at least one calculation region to allocate the M memory blocks, so that when performing subsequent steps, the M memory blocks can be confirmed to be sequential or separated.

In one embodiment, when a number of a plurality of available blocks in one of the plurality of available regions is larger than or equal to the block number, the processing circuit is configured to select the one of the plurality of available regions as to allocate the M memory blocks. That is, the memory device can use multiple adjacent memory blocks to perform calculation.

In one embodiment, the processing circuit is further configured for: inputting the plurality of operation data according to an index sequence of the M memory blocks to perform the vector-matrix multiplication.

In one embodiment, the at least one calculation region comprises a plurality of calculation regions, and the plurality of calculation regions is not adjacent to each other. The processing circuit is configured to allocate a plurality of available blocks in the plurality of calculation regions as the M memory blocks to efficiently utilize all space within the memory array.

In one embodiment, the processing circuit is further configured for: dividing the plurality of operation data into a plurality of section data, wherein the plurality of section data corresponds to a number of the plurality of calculation regions; and providing the plurality of section data of the plurality of operation data to the M memory blocks sequentially according to an index sequence of the M memory blocks in the plurality of calculation regions to perform the vector-matrix multiplication.

In one embodiment, the plurality of weight values comprises a plurality of calculation weight values, at least one balanced weight value and at least one series weight value. Each of the plurality of memory strings comprises a plurality of calculation weight units, at least one balanced weight unit and at least one series weight unit. The plurality of calculation weight units is configured to be set the plurality of calculation weight values. The at least one balanced weight unit is connected in series to the plurality of calculation weight units. The at least one balanced weight unit is configured to be set the at least one balanced weight value. The at least one series weight unit is connected in series to the at least one balanced weight uni. The at least one series weight unit is configured to be set the at least one series weight value. Accordingly, adjusting the overall impedance of the memory string through the weight units will make the calculation results of the sensing circuit more accurate.

Another aspect of the present disclosure is a memory operation method, comprising: obtaining, by a processing circuit, a plurality of operation data of a vector-matrix multiplication, wherein the processing circuit is coupled to a memory array, and the memory array comprises a plurality of memory blocks; calculating a block number in the plurality of memory blocks required to store the plurality of operation data; allocating M memory blocks in the plurality of memory blocks according to the block number; and providing the plurality of operation data to the M memory blocks, so that the memory array outputs an output current according to the plurality of operation data and a plurality of weight values set in the M memory blocks. Accordingly, by selectively allocating the operation data to different regions of the memory array, vector-matrix multiplication can be realized more flexibly.

In one embodiment, the memory array comprises a plurality of available regions, and allocating the M memory blocks in the plurality of memory blocks comprises: selecting at least one of the plurality of available regions as at least one calculation region to allocate the M memory blocks, so that when performing subsequent steps, the M memory blocks can be confirmed to be sequential or separated.

In one embodiment, allocating the M memory blocks in the plurality of memory blocks further comprises: when a number of a plurality of available blocks in one of the plurality of available regions is larger than or equal to the block number, selecting the one of the plurality of available regions as to allocate the M memory blocks, so that when performing subsequent steps, the M memory blocks can be confirmed to be sequential or separated. That is, the memory device can use multiple adjacent memory blocks to perform calculation.

In one embodiment, allocating the M memory blocks in the plurality of memory blocks further comprises: inputting the plurality of operation data according to an index sequence of the M memory blocks to perform the vector-matrix multiplication.

In one embodiment, the at least one calculation region comprises a plurality of calculation regions, the plurality of calculation regions is not adjacent to each other, and allocating the M memory blocks in the plurality of memory blocks comprises: allocating a plurality of available blocks in the plurality of calculation regions as the M memory blocks to efficiently utilize all space within the memory array.

In one embodiment, allocating the M memory blocks in the plurality of memory blocks further comprises: dividing the plurality of operation data into a plurality of section data, wherein the plurality of section data corresponds to a number of the plurality of calculation regions; and providing the plurality of section data of the plurality of operation data to the M memory blocks sequentially according to an index sequence of the M memory blocks in the plurality of calculation regions to perform the vector-matrix multiplication.

Another aspect of the present disclosure is a memory operation method, comprising: obtaining, by a processing circuit, a plurality of operation data of a vector-matrix multiplication, wherein the processing circuit is coupled to a memory array, and the memory array comprises a plurality of memory strings; converting the plurality of operation data to a plurality of operation codes, wherein each of the plurality of operation codes corresponds to each of the plurality of operation data, and the plurality of operation codes is arranged as a plurality of initial rows of an initial array; adjusting an arrangement of a plurality of bits of each of the plurality of operation codes to form an adjusted array, wherein a difference between a plurality of adjusted columns of the adjusted array is less than a difference between a plurality of initial columns of the initial array; and inputting the plurality of operation codes to the plurality of memory strings according to the adjusted array, so that the plurality of memory strings outputs an output current according to a plurality of weight values set in the plurality of memory strings. Accordingly, the calculation accuracy of the sensing circuit will be improved.

In one embodiment, a format of the plurality of operation codes is Unary encoding, so as to reduce the problem of serious interpretation errors caused by slight transmission errors when transmitting the operation data.

In one embodiment, inputting the plurality of operation codes to the plurality of memory strings comprises: selecting a plurality of available regions in the memory array as a plurality of calculation regions; dividing the plurality of operation codes into a plurality of section data, wherein the plurality of section data corresponds to a number of the plurality of calculation regions; and providing the plurality of section data of the plurality of operation codes to the plurality of memory strings in the plurality of calculation regions sequentially, so that when performing subsequent steps, the M memory blocks can be confirmed to be sequential or separated, so that when performing subsequent steps, the M memory blocks can be confirmed to be sequential or separated.

In one embodiment, adjusting the arrangement of the plurality of bits of each of the plurality of operation codes comprises: moving a plurality of bits with value 1 in a plurality of odd rows of the initial array toward a first direction; and moving a plurality of bits with value 1 in a plurality of even rows of the initial array toward a second direction, wherein the first direction and the second direction are opposite. Accordingly, a difference between a plurality of adjusted columns of the adjusted array is less than a difference between a plurality of initial columns of the initial array.

In one embodiment, adjusting the arrangement of the plurality of bits of each of the plurality of operation codes comprises: dividing the plurality of initial columns into a first group, a second group and a third group according to the difference between the plurality of initial columns, wherein a plurality of bits in the first group are all 1, and a plurality of bits in the second group are all 0; and ignoring the second group. Accordingly, the number of input the operation codes will be reduced.

In one embodiment, adjusting the arrangement of the plurality of bits of each of the plurality of operation codes further comprises: moving a plurality of bits with value 1 in a part of a plurality of adjusted rows of the adjusted array toward a first direction; and moving a plurality of bits with value 1 in another part of the plurality of adjusted rows of the adjusted array toward a second direction, wherein the first direction and the second direction are opposite. Accordingly, the bits can be distributed more evenly.

In one embodiment, inputting the plurality of operation codes to the plurality of memory strings comprises: inputting the first group into the plurality of memory strings once to obtain an operation value; and copying the operation value according to a number of the plurality of initial columns in the first group. Accordingly, the number of times to input the operation codes will be reduced.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a memory device in some embodiments of the present disclosure.

FIG. 2 is a schematic diagram of multiple memory strings in some embodiments of the present disclosure.

FIG. 3 is a flowchart illustrating a memory operation method in some embodiments of the present disclosure.

FIG. 4 is a schematic diagram of the operation of the memory device in some embodiments of the present disclosure.

FIG. 5A is a schematic diagram of the operation of the memory device in some embodiments of the present disclosure.

FIG. 5B is a schematic diagram of the operation of the memory device in some embodiments of the present disclosure.

FIG. 6 is a schematic diagram of an initial array in some embodiments of the present disclosure.

FIG. 7 is a flowchart illustrating a memory operation method in some embodiments of the present disclosure.

FIG. 8 is a schematic diagram of an adjusted array in some embodiments of the present disclosure.

FIG. 9 is a schematic diagram of an adjusted array in some embodiments of the present disclosure.

FIG. 10 is a schematic diagram of an adjusted array in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being "connected to" or "coupled to", it can be directly connected or coupled to the other element or intervening elements may be present. In contrast, when an element to another element is referred to as being "directly connected" or "directly coupled," there are no intervening elements present. As used herein, the term "and/or" includes an associated listed items or any and all combinations of more.

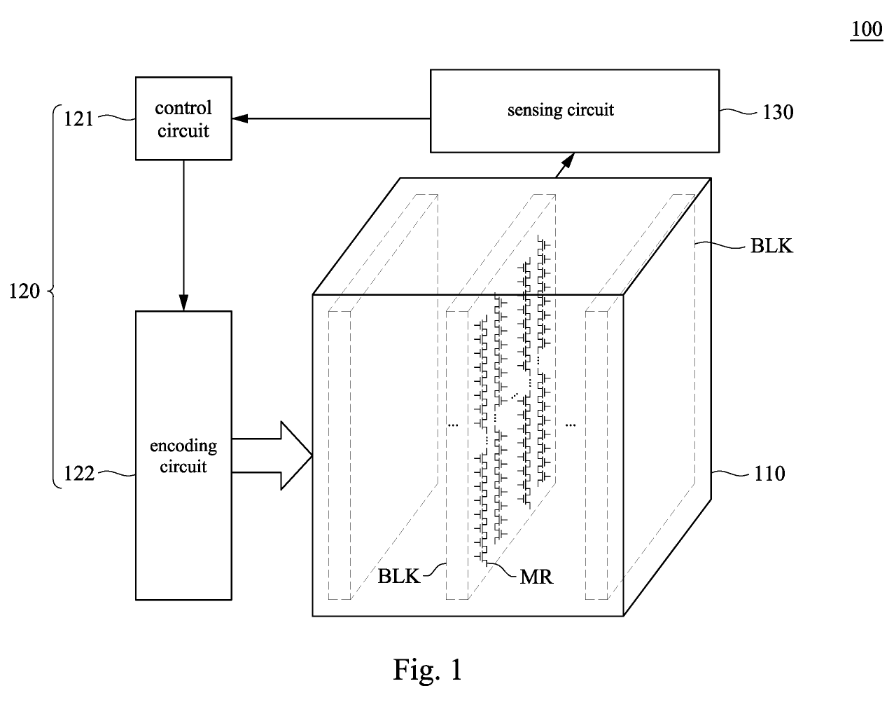

FIG. 1 is a schematic diagram of a memory device 100 in some embodiments of the present disclosure. The memory device 100 is configured to implement “In Memory Computing” (IMC), and performs a vector-matrix multiplication (VMM), such as the Multiply-and-Accumulate (MAC) calculation commonly used in artificial intelligence (AI) technology.

The memory device 100 includes a memory array 110, a processing circuit 120 and a sensing circuit 130. The memory array 110 is coupled to the processing circuit 120 through multiple word lines and multiple bit lines, and includes the multiple memory blocks BLK. Each of the memory blocks BLK includes multiple memory strings MR, and each of the memory strings MR includes multiple memory units (memory cell). In one embodiment, the memory string MR can be a kind of NAND string.

The processing circuit 120 is coupled to the memory array 110 through the word lines and the bit lines to provide data about the vector-matrix multiplication. In one embodiment, the processing circuit 120 can include a control circuit 121 and an encoding circuit 122, the control circuit 121 is configured to provide an original data of the vector-matrix multiplication, and the encoding circuit 122 is configured to encode the original data to input to the memory array 110. The circuit structure of the processing circuit 120 is not limited to the structure shown in FIG. 1. In the subsequent paragraphs, the execution step of the processing circuit 120 may be performed by either the control circuit 121 or the encoding circuit 122.

When performing the vector-matrix multiplication, the processing circuit 120 is configured to provide the input data of the vector-matrix multiplication (hereinafter referred to as “operation data”) through the word lines and the bit lines to the memory array 110. The memory array 110 generates an output current according to multiple weight values preset internally. The sensing circuit 130 is coupled to the memory array 110, and is configured to receive the output current generated by the memory array 110 to calculate a calculation result, such as calculating the total impedance according to the sum of currents.

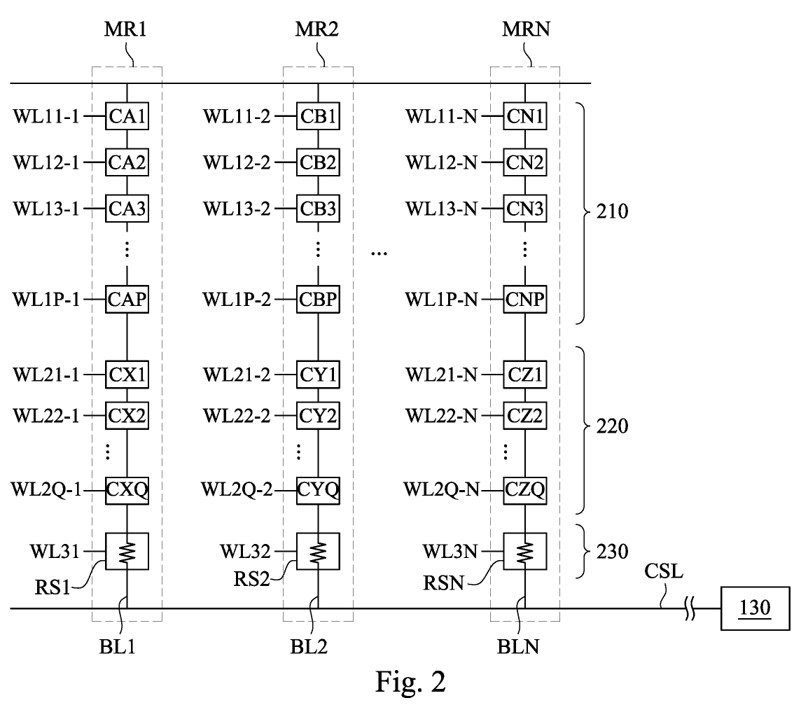

FIG. 2 is a schematic diagram of multiple memory strings in some embodiments of the present disclosure. The memory strings MR1-MRN can be implemented to any one of the memory blocks BLK shown in FIG. 1. The memory strings MR1-MRN shown in FIG. 2 are two-dimensional structures, but in other embodiments, the memory blocks BLK may include a three-dimensional memory string structure.

Referring to FIG. 1 and FIG. 2, the memory strings MR1-MRN respectively include multiple memory units CA1-CAP, CB1-CBP, CN1-CNP, each memory unit is set to have a weight value. Taking "Multiply-and-Accumulate calculation" as an example, "weight value" can be a product coefficient used in artificial intelligence/neural networks. "Weight value" can be determined by the respective conductance value (or impedance value) of each memory unit, and the conductance value of the memory unit depends on its threshold voltage. By applying voltage to each memory unit, the amount of charge in the floating gate can be controlled to change the threshold voltage.

Taking the structure shown in FIG. 2 as an example, the operation of the memory string when performing the vector-matrix multiplication is as follows: in one embodiment, the memory strings MR1-MRN receive a read voltage through the bit lines BL1-BLN, and receive the respective operation data through the respective word lines WL11-1~WL1P-1, WL11-2~WL1P-2, WL11-N~WL1P-N (e.g., the word line WL11-1 provides the respective operation data to the memory unit CA1, the word line WL11-2 provides the respective operation data to the memory unit CB1). Each of the memory strings MR1-MRN generates a unit current according to the preset weight values and the received read voltage, and all unit currents outputs to the sensing circuit 130 through a common source line CSL to calculate result. In one embodiment, "operation data" can be a voltage signal corresponding to a binary code (including multiple bits), which will be described in detail in the subsequent paragraphs.

In some embodiments, the above weight value can include multiple calculation weight values, at least one balanced weight value and at least one series weight value. The memory units CA1-CAP, CB1-CBP, CN1-CNP in the memory string can be used as multiple calculation weight unit 210, and are configured to be set the calculation weight values. Each memory string further includes at least one balanced weight unit 220 and at least one series weight unit 230. The balanced weight unit 220 is configured to adjust the equivalent impedance value of each memory string, and is configured to be adjust the standard deviation of all weight values. The impedance value of the series weight unit 230 depends on the overall impedance of each memory string, and the series weight unit 230 is configured to make each memory string have a basic impedance value. In other words, the balanced weight unit 220 and the series weight unit 230 are not configured to perform Multiply-and-Accumulate calculation directly, but are configured to adjust the overall impedance of the corresponding memory string to make the calculation result of the sensing circuit 130 more accurate.

Specifically, the calculation weight unit 210 and the balanced weight unit 220 can be implemented with the same type of memory unit, such as the transistor units CX1-CXQ, CY1-CYQ and CZ1-CZQ shown in FIG. 2. The balanced weight unit 220 of the memory strings can also receive a respective setting signal through the respective word lines WL21-1~WL2Q-1, WL21-2~WL2Q-2, WL21-N~WL2Q-N to set the respective balanced weight values. The series weight unit 230 can be implemented by the impedance elements RS1-RSN (e.g., resistors), and can receive a respective setting signal through the respective word lines WL31~WL3N to set the respective series weight value.

Referring to FIG. 1, when performing the vector-matrix multiplication, the operation data (i.e., the input data to be calculated) is usually input to multiple adjacent memory blocks BLK to perform calculation by the memory string in the adjacent memory blocks BLK. However, when the operation data is too large, the memory array 110 does not necessarily have enough space, if erasing/moving the data in the memory array 110 temporarily to obtain space, it will affect the efficiency of the calculation. Therefore, the memory device 100 can selectively allocate the operation data to the memory blocks BLK in different regions in the memory array 110 to perform the vector-matrix multiplication more flexibly.

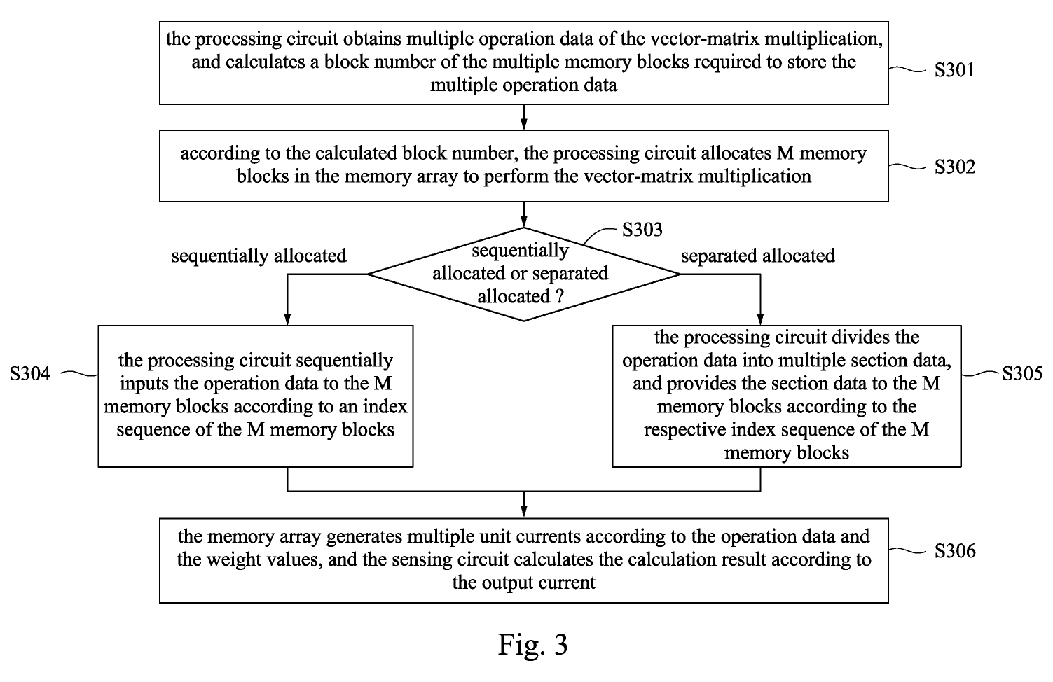

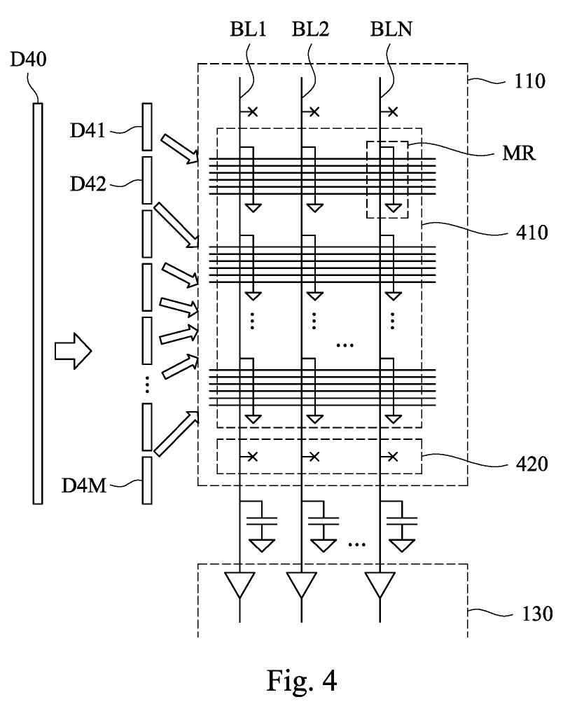

FIG. 3 is a flowchart illustrating a memory operation method in some embodiments of the present disclosure. FIG. 4 is a schematic diagram of the operation of the memory device in some embodiments of the present disclosure, which can correspond to FIG. 1. Take FIGS. 1-4 as an example to illustrate the operation of the memory device 100. In step S301, the processing circuit 120 obtains multiple operation data (FIG. 4 simplifies to label multiple operation data as D40) of the vector-matrix multiplication. According to the operation data D40, the processing circuit 120 first calculates a block number of the multiple memory blocks BLK required to store the multiple operation data. Here, the required block number is called "M", where M is a positive integer greater than 1.

In step S302, according to the calculated block number, the processing circuit 120 is configured to assign/select/allocate the M memory blocks BLK in the memory array 110. In some embodiments, the processing circuit 120 selects one or more region from multiple available regions as a calculation region, so that when performing subsequent steps, the memory device can clearly known whether the M memory blocks BLK are sequential or separated. The adjacent multiple memory blocks BLK in the calculation region will be allocated as the M memory blocks BLK that perform the vector-matrix multiplication.

In order to facilitate the distinction between "memory blocks in the available regions" and "memory blocks in other regions", "memory blocks in the available regions" are here referred to as “available blocks”. Taking FIG. 4 as an example, the memory array 110 includes multiple available regions 410, 420. If a number of multiple available blocks in one of the multiple available regions is larger than or equal to the block number, the processing circuit 120 can select/set this available region as the calculation region to allocate the M memory blocks BLK required to perform the vector-matrix multiplication. That is, the memory device 100 can use the adjacent multiple memory blocks BLK to perform calculation.

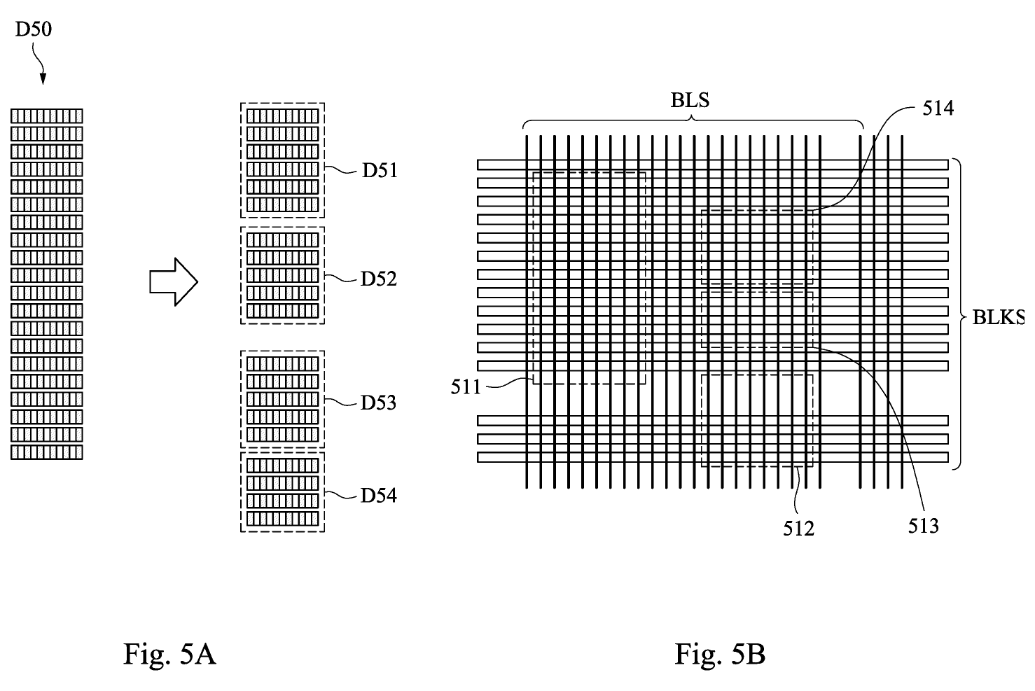

FIG. 5A and FIG. 5B are schematic diagrams of the operation of the memory device in some other embodiments of the present disclosure, wherein FIG. 5B is a simplified partial schematic diagram of the memory array 110. The memory array 110 is coupled to multiple bit lines BLS, and includes multiple memory blocks BLKS. The memory blocks BLKS are respectively arranged in multiple available regions 511-514, and the available regions 511-512 are not adjacent to the available regions 513-514. When a number of the available blocks in each available regions 511-514 is less than the block number, the processing circuit 120 selects multiple available blocks in multiple available regions 511-514, which are not adjacent to each other (i.e., as calculation regions), to allocate the M memory blocks to effectively utilize all the space in the memory array 110.

In step S303, the processing circuit 120 determines the M memory blocks BLK and the memory strings inside is “sequentially allocated” or “separated allocated”, so as to determine how to input the operation dat subsequently. The determination can use the allocation method in step S302. If a single calculation region has the block number of the memory blocks BLK, “sequentially allocated” is used (as shown in FIG. 4). On the other hand, if the M memory blocks BLK are allocated in multiple calculation regions not adjacent to each other, “separated allocated” is used.

Step S304 illustrates the operation of "sequentially allocated". Referring to FIG. 4, the M memory blocks BLK are allocated in the same available region 410, that is, the M memory blocks BLK will be adjacent to each other. Therefore, the processing circuit 120 can sequentially input the operation data D40 to the memory strings of the M memory blocks BLK according to an index sequence of the M memory blocks BLK to perform the vector-matrix multiplication. In other words, each memory block receives a part of the operation data D40, as shown in FIG. 4 as multiple section data D41-D4M.

Step S305 illustrates the operation of "separated allocated". Referring to FIG. 5A and FIG. 5B, since the M memory blocks BLK are allocated in multiple calculation regions not adjacent to each other (available regions 511-514), the processing circuit 120 needs to actively divide the operation data D50 into multiple section data D51-D54, and the number of the section data will correspond to the number of the calculation regions (available regions 511-514). Then, the processing circuit 120 provides the section data D51-D54 to the memory strings of the M memory blocks BLK according to the respective index sequence of the M memory blocks BLK in the calculation regions (the available regions 511-514), so as to perform the vector-matrix multiplication.

After inputting the operation data D40/D50 by step S304 or step S305, in step S306, the memory array 110 generates multiple unit currents according to the received operation data D40/D50 and the preset weight values in the M memory blocks. Then, the sensing circuit 130 receives the unit currents, and sums the unit currents into an output current. According to the output current, the calculation result can be calculated.

Accordingly, by allocating multiple operation data to different memory blocks, the multiple memory strings of different memory blocks will be able to perform the same vector-matrix multiplication, making the space utilization of the memory device 100 more flexible.

In addition, the present disclosure can further change the input method of the operation data to improve the sensing accuracy of the sensing circuit 130. Take the vector-matrix multiplication shown in FIG. 2 as an example, ideally, the average impedance value of all memory strings MR1-MRN participating in the calculation will be the calculation result of the vector-matrix multiplication. However, the sensing circuit 130 measures the total resistance of all memory strings MR1-MRN. Therefore, there will be an error between the measurement result of the sensing circuit 130 and the real calculation result. One of the obvious error term is the standard deviation of the distribution of all weight values. The smaller the standard deviation of the distribution, the more accurate the calculation result of the sensing circuit 130 can be.

For ease of understanding, before explaining how to reduce the standard deviation of the weight values, the format used by the processing circuit 120 to input "the operation data" (i.e., the input value of the vector-matrix multiplication) is explained here. The processing circuit 120 first converts multiple operation data into multiple operation codes, and then inputs the operation codes into the memory strings for calculation. In some embodiments, the processing circuit 120 converts the format of the operation data into "Unary coding". This format can reduce the problem of serious interpretation errors caused by slight transmission errors when transmitting the operation data.

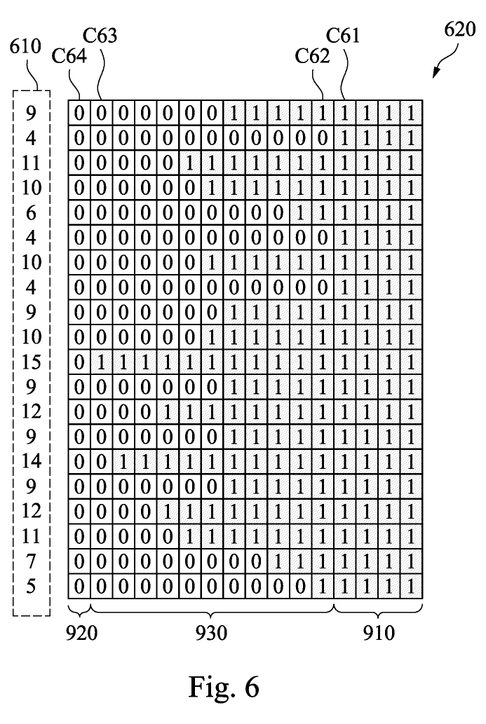

Unary coding uses the number of “bit 1 (bit with value 1)" to represent the real value. Therefore, even if a few bits are incorrect during data transmission, the actual read value will not be too different from the real value. FIG. 6 is a schematic diagram of an initial array in some embodiments of the present disclosure. in one embodiment, the operation data 610 for the vector-matrix multiplication includes “9, 4, 11, 10, 6, 4, 10, 4, 9, 10, 15, 9, 12, 9, 14, 9, 12, 11, 7, 5". The processing circuit 120 converts the multiple operation data 610 into multiple operation codes, and the multiple operation codes can be organized into an initial array 620. As shown in FIG. 6, each row of the initial array 620 (hereinafter referred to as "initial row") is one operation code including multiple bits, and each row corresponds to one of the operation data. For example, the operation code "0000000111111111" represents the operation data "9" (the number of “bit 1” is 9).

When performing calculations, the processing circuit 120 inputs bits in the operation codes into the corresponding multiple memory strings in columns. As mentioned before, the smaller the standard deviation of the weight value, the more accurate the calculation result of the sensing circuit 130 can be. Therefore, the more evenly distributed the bits in the operation codes are, the smaller the standard deviation can be. The initial array 620 shown in FIG. 6 is not evenly distributed (“bit 1” is concentrated in the right half), so it is not ideal in calculation.

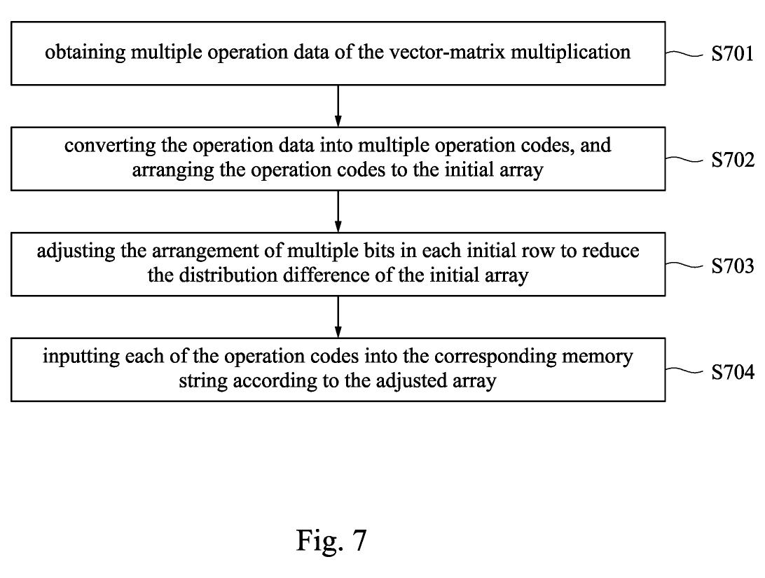

FIG. 7 is a flowchart illustrating a memory operation method in some embodiments of the present disclosure, which is used to illustrate changing the input method of the operation data 610. Referring to FIG. 1, FIG. 6 and FIG. 7, in step S701, the processing circuit 120 obtains multiple operation data 610 of the vector-matrix multiplication. In step S702, the processing circuit 120 converts the operation data 610 into multiple operation codes. Each operation code corresponds to each operation data, and can be arranged to the initial row of the initial array 620.

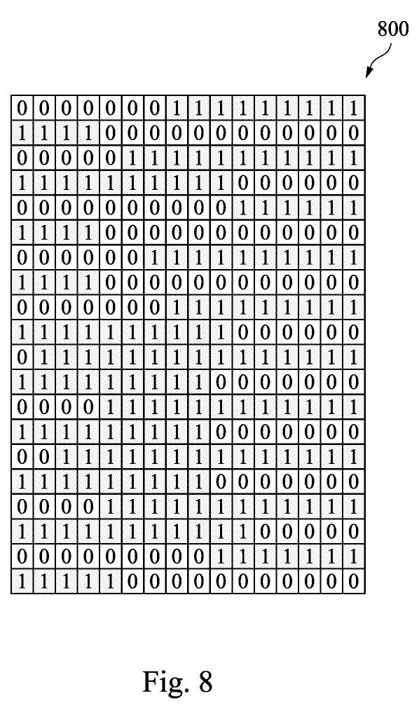

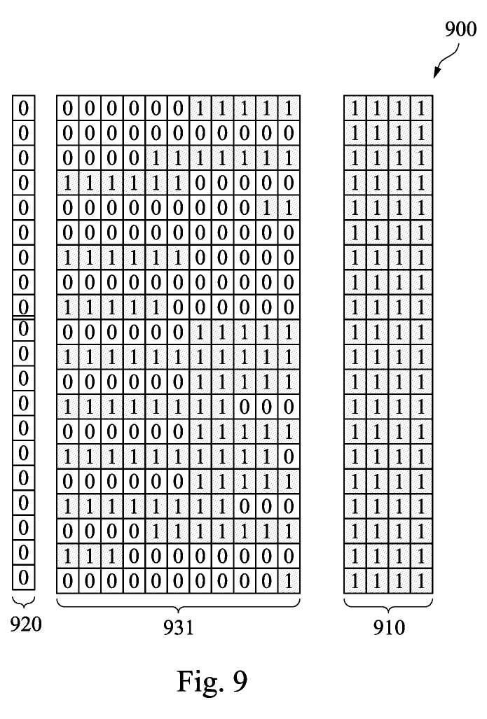

In step S703, the processing circuit 120 adjusts the arrangement of multiple bits in each initial row to reduce the distribution difference of “bit 1” or “bit 0” in the initial array 620. The adjusted initial array 620 is called the adjusted array, such as the adjusted array 800, 900 shown in FIG. 8 and FIG. 9. The difference between multiple adjusted columns of the adjusted array is less than the difference between multiple initial columns of the initial array. In other words, the distribution of "bit 1" in the adjusted array will be more evenly than the distribution of "bit 1" in the initial array 620.

In step S704, the processing circuit 120 inputs each of the operation codes into the corresponding memory string according to the adjusted array, so that the memory string outputs the output current according to the multiple weight values set in the memory string. Inputting the operation codes into the memory string can be performed in a similar way to the steps shown in FIG. 2. That is, the available region(s) of the memory array 110 can be selected as the calculation region. At the same time, the operation codes are divided into the multiple section data, and then the section data are sequentially input into the memory strings of the calculation regions.

FIG. 8 and FIG. 9 respectively illustrate different embodiments of adjusting the initial array 620 to the adjusted array, corresponding to the above step S703. In the embodiment of FIG. 8, the processing circuit 120 moves all "bit 1" in the odd rows of the initial array 620 toward a first direction (e.g., the right side of FIG. 8). At the same time, all "bit 1" in the even rows in the initial array 620 are moved toward a second direction (e.g., the left side of FIG. 8). The first direction and the second direction are opposite, so as to generate the adjusted array 800. Accordingly, the difference between each column in the adjusted array 800 will be less than the difference between each column in the initial array 620.

FIG. 9 shows another embodiment of adjusting the initial array 620 to the adjusted array. In this embodiment, the processing circuit 120 divides the initial columns into a first group 910, a second group 920 and a third group 930 according to the difference degree between the initial columns (i.e., the ratio of “bit 0” and “bit 1”). Referring to FIG. 6 and FIG. 9, the first group 910 is the initial column of "all bits are value 1", the second group 920 is the initial column of "all bits are value 0", and the other initial column will be classified/divided as the third group. As shown in FIG. 9, the adjusted array 900 has the same first group 910 and the second group 920 as the initial array 620. In other words, the first group 910 of the initial columns can directly use as the adjusted column. Similarly, the second group 920 of the initial columns can be directly used as the adjusted column. Regarding the adjusted third group 931 of the adjusted array 900, the adjustment method will be explained in the subsequent paragraphs.

As mentioned above, since the adjusted columns of the first group 910 are all the same, when the processing circuit 120 inputs the operation codes, the processing circuit 120 only needs to input one adjusted column of the first group 910 to the corresponding memory string once. Then, the sensing circuit 130 copys the operation value (sensing result, such as unit current) according to a number of multiple initial columns in the first group. For example, the first group 910 includes K adjusted columns, so the processing circuit 120 input one the operation code “all bits are value 1” once, then, the sensing circuit 130 uses the unit current generated by the memory string as the operation value, and copies the operation value K times (i.e., the number of the adjusted columns of the first group). Accordingly, the number of times to input the operation codes can be reduced, and the probability of calculation errors can be reduced.

On the other hand, since all the bits included in the adjusted columns of the second group 920 are "bit 0", there is no need to input. The processing circuit 120 can ignore the adjusted columns of the second group "all bits are value 0", that is, there is no need to input it to the memory string.

The following explains how to rearrange the initial columns of the third group 930 to form the adjusted third group 931. In one embodiment, the array formed by the initial columns of the third group 930 can be adjusted by the method described in FIG. 8. Referring to FIG. 6 and FIG. 9, the processing circuit 120 moves multiple “bit 1” in a part of multiple adjusted rows (e.g., the odd rows in the array formed by the initial columns of the third group 930) toward a first direction. At the same time, the processing circuit 120 moves multiple “bit 0” in another part of multiple adjusted rows (e.g., the even rows in the array formed by the initial columns of the third group 930) toward a second direction. The first direction and the second direction are opposite. Accordingly, the difference between the initial columns of the third group 930 can be reduced in an adjustment method similar to FIG. 8.

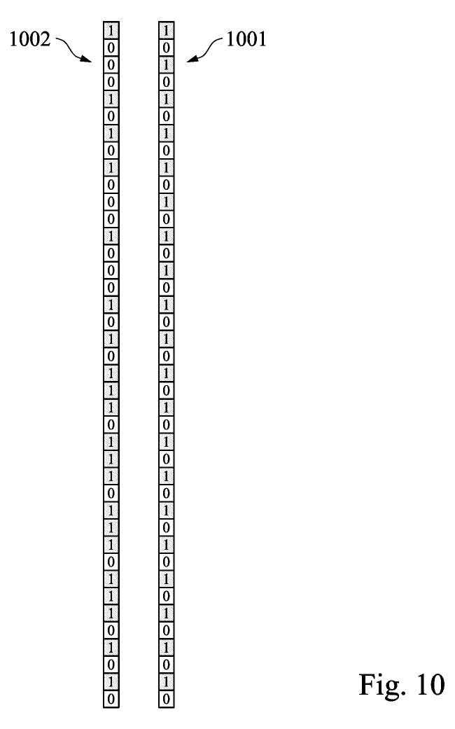

FIG. 10 shows another embodiment of adjusting the initial array to the adjusted array. Referring to FIG. 6 and FIG. 10, the processing circuit 120 selects any two of the initial columns (e.g., one row from the left and one row from the right) in the initial array 620, and combine the bits in the two initial columns in a staggered manner to form a new adjusted column. For example, the processing circuit 120 selects the initial columns S61 and S64, and staggers the bits of the two initial columns to form the adjusted column 1001. Similarly, the processing circuit 120 selects the initial columns S62 and S63, and staggers the bits of the two initial columns to form the adjusted column 1002. The aforementioned "staggered manner" refers to sequentially selecting a bit from the two initial columns and arranging them into two bits of the adjusted column. Accordingly, the distribution of bits will be made more even, thereby reducing the standard deviation of the weight values at input.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A memory device, comprising:
a memory array coupled to a plurality of word lines and a plurality of bit lines, and comprising a plurality of memory blocks, wherein each of the plurality of memory blocks comprises a plurality of memory strings;
a sensing circuit coupled to the memory array, and configured to receive an output current output by the memory array; and
a processing circuit coupled to the memory array, and configured to calculate a block number in the plurality of memory blocks required to store a plurality of operation data of a vector-matrix multiplication;
wherein the processing circuit is further configured for:
allocating M memory blocks in the plurality of memory blocks according to the block number; and
providing the plurality of operation data to the M memory blocks, so that the memory array outputs the output current according to the plurality of operation data and a plurality of weight values set in the M memory blocks.

2. The memory device of claim 1, wherein the memory array comprises a plurality of available regions, and the processing circuit is configured to select at least one of the plurality of available regions as at least one calculation region to allocate the M memory blocks.

3. The memory device of claim 2, wherein when a number of a plurality of available blocks in one of the plurality of available regions is larger than or equal to the block number, the processing circuit is configured to select the one of the plurality of available regions as to allocate the M memory blocks.

4. The memory device of claim 3, wherein the processing circuit is further configured for:
inputting the plurality of operation data according to an index sequence of the M memory blocks.

5. The memory device of claim 2, wherein the at least one calculation region comprises a plurality of calculation regions, the plurality of calculation regions is not adjacent to each other, and the processing circuit is configured to allocate a plurality of available blocks in the plurality of calculation regions as the M memory blocks.

6. The memory device of claim 5, wherein the processing circuit is further configured for:
dividing the plurality of operation data into a plurality of section data, wherein the plurality of section data corresponds to a number of the plurality of calculation regions; and
providing the plurality of section data of the plurality of operation data to the M memory blocks sequentially according to an index sequence of the M memory blocks in the plurality of calculation regions.

7. The memory device of claim 1, wherein the plurality of weight values comprises a plurality of calculation weight values, at least one balanced weight value and at least one series weight value, and each of the plurality of memory strings comprises:
a plurality of calculation weight units, wherein the plurality of calculation weight units is configured to be set the plurality of calculation weight values;
at least one balanced weight unit connected in series to the plurality of calculation weight units, wherein the at least one balanced weight unit is configured to be set the at least one balanced weight value; and
at least one series weight unit connected in series to the at least one balanced weight unit, wherein the at least one series weight unit is configured to be set the at least one series weight value.

8. A memory operation method, comprising:
obtaining, by a processing circuit, a plurality of operation data of a vector-matrix multiplication, wherein the processing circuit is coupled to a memory array, and the memory array comprises a plurality of memory blocks;
calculating a block number in the plurality of memory blocks required to store the plurality of operation data;
allocating M memory blocks in the plurality of memory blocks according to the block number; and
providing the plurality of operation data to the M memory blocks, so that the memory array outputs an output current according to the plurality of operation data and a plurality of weight values set in the M memory blocks.

9. The memory operation method of claim 8, wherein the memory array comprises a plurality of available regions, and allocating the M memory blocks in the plurality of memory blocks comprises:
selecting at least one of the plurality of available regions as at least one calculation region to allocate the M memory blocks.

10. The memory operation method of claim 9, wherein allocating the M memory blocks in the plurality of memory blocks further comprises:
when a number of a plurality of available blocks in one of the plurality of available regions is larger than or equal to the block number, selecting the one of the plurality of available regions as to allocate the M memory blocks.

11. The memory operation method of claim 10, wherein allocating the M memory blocks in the plurality of memory blocks further comprises:
inputting the plurality of operation data according to an index sequence of the M memory blocks.

12. The memory operation method of claim 9, wherein the at least one calculation region comprises a plurality of calculation regions, the plurality of calculation regions is not adjacent to each other, and allocating the M memory blocks in the plurality of memory blocks comprises:
allocating a plurality of available blocks in the plurality of calculation regions as the M memory blocks.

13. The memory operation method of claim 12, wherein allocating the M memory blocks in the plurality of memory blocks further comprises:
dividing the plurality of operation data into a plurality of section data, wherein the plurality of section data corresponds to a number of the plurality of calculation regions; and
providing the plurality of section data of the plurality of operation data to the M memory blocks sequentially according to an index sequence of the M memory blocks in the plurality of calculation regions.

14. A memory operation method, comprising:
obtaining, by a processing circuit, a plurality of operation data of a vector-matrix multiplication, wherein the processing circuit is coupled to a memory array, and the memory array comprises a plurality of memory strings;
converting the plurality of operation data to a plurality of operation codes, wherein each of the plurality of operation codes corresponds to each of the plurality of operation data, and the plurality of operation codes is arranged as a plurality of initial rows of an initial array;
adjusting an arrangement of a plurality of bits of each of the plurality of operation codes to form an adjusted array, wherein a difference between a plurality of adjusted columns of the adjusted array is less than a difference between a plurality of initial columns of the initial array; and
inputting the plurality of operation codes to the plurality of memory strings according to the adjusted array, so that the plurality of memory strings outputs an output current according to a plurality of weight values set in the plurality of memory strings.

15. The memory operation method of claim 14, wherein a format of the plurality of operation codes is Unary encoding.

16. The memory operation method of claim 14, wherein inputting the plurality of operation codes to the plurality of memory strings comprises:
selecting a plurality of available regions in the memory array as a plurality of calculation regions;
dividing the plurality of operation codes into a plurality of section data, wherein the plurality of section data corresponds to a number of the plurality of calculation regions; and
providing the plurality of section data of the plurality of operation codes to the plurality of memory strings in the plurality of calculation regions sequentially.

17. The memory operation method of claim 14, wherein adjusting the arrangement of the plurality of bits of each of the plurality of operation codes comprises:
moving a plurality of bits with value 1 in a plurality of odd rows of the initial array toward a first direction; and
moving a plurality of bits with value 1 in a plurality of even rows of the initial array toward a second direction, wherein the first direction and the second direction are opposite.

18. The memory operation method of claim 14, wherein adjusting the arrangement of the plurality of bits of each of the plurality of operation codes comprises:
dividing the plurality of initial columns into a first group, a second group and a third group according to the difference between the plurality of initial columns, wherein a plurality of bits in the first group are all 1, and a plurality of bits in the second group are all 0; and
ignoring the second group.

19. The memory operation method of claim 18, wherein adjusting the arrangement of the plurality of bits of each of the plurality of operation codes further comprises:
moving a plurality of bits with value 1 in a part of a plurality of adjusted rows of the adjusted array toward a first direction; and
moving a plurality of bits with value 1 in another part of the plurality of adjusted rows of the adjusted array toward a second direction, wherein the first direction and the second direction are opposite.

20. The memory operation method of claim 18, wherein inputting the plurality of operation codes to the plurality of memory strings comprises:
inputting the first group into the plurality of memory strings once to obtain an operation value; and
copying the operation value according to a number of the plurality of initial columns in the first group.
